(19) United States
(12) Patent Application Publication
(10) Pub. No.: US 2010/0043914 A1
(43) Pub. Date: Feb. 25, 2010

(54) INFLATION VALVE

(75) Inventor: Bester Jacobus PANSEGROUW, Ottery (ZA)

Correspondence Address: SUMMA, ADDITON & ASHE, P.A., 11610 NORTH COMMUNITY HOUSE ROAD, SUITE 200, CHARLOTTE, NC, 28277, US

(73) Assignee: STOPAK (PTY) LTD., Ottery (ZA)

(21) Appl. No.: 12/558,013

(22) Filed: Sep. 11, 2009

Related U.S. Application Data
(63) Continuation of application No. PCT/IB2008/050866, filed on Mar. 10, 2008.

(30) Foreign Application Priority Data
Mar. 13, 2007 (ZA) ZA2007/01285

(51) Int. Cl. B65B 3/04; F16K 15/20

(52) U.S. Cl. 141/10; 137/232

(57) ABSTRACT

An inflation valve for inflating containers with non-rigid walls, has a body with a passage and first tubular part with a first opening at one end leading into the passage and a second opening at its opposite end leading into the passage. A cap is removably fitted over the body for closing the first opening to the passage. A first sealing disc, which closes off the second opening to the passage, is adapted to open the second opening when an inflation device is inserted into the second opening to allow gas to be inserted into the container through the second opening. A guide member is located within the first tubular part to support a spring for assisting the first sealing disc in closing off the second opening.

### CROSS-REFERENCE TO PRIORITY APPLICATIONS

This application is a continuation of and hereby claims the benefit of the commonly assigned South African Patent Application Serial No. 2007/01285 (filed Mar. 13, 2007), and the commonly assigned International Patent Application No. PCT/IB2008/050866 (filed Mar. 10, 2008), both of which are hereby incorporated by reference in their entirety.

### FIELD OF THE INVENTION

The present invention relates to inflation valves. More particularly, the invention relates to inflation valves for inflating containers with non-rigid-walls, such as dunnage bags.

### BACKGROUND

Inflatable dunnage bags are commonly used for cushioning loads shipped in trucks, trailers and containers transported by ships, trucks or rail. This is often the case when the cargo only partially fills the container and there exists the possibility of shifting during transport that could cause damage. Typically known dunnage bags are constructed of one or more layers of paper surrounding a plastic lining. The paper protects the bags from tearing—thus more layers are used in applications where the risk of damage to the dunnage bag is greater. Furthermore, for inflating and deflating the dunnage bag, a valve is attached by way of a hole cut in the bag during manufacture.

The dunnage bags are shipped flat from the manufacturer, and are inflated by packing and loading personnel as the containers are loaded with cargo. The bag is firstly placed in the space that it will occupy as cargo is loaded into a container, secondly the inflation device is attached to a valve of the dunnage bag and subsequently the dunnage bag is filled with air until an appropriate air pressure within the bag is achieved. Often this occurs within a few seconds.

Unfortunately the known type of inflation valves are difficult to operate and not flexible in operation and thus suffer from important limitations.

It is an object of the invention to suggest an inflation device which will assist in overcoming the aforesaid problems.

### SUMMARY OF THE INVENTION

According to the invention, an inflation valve for inflating containers with non-rigid walls, includes:

a body including a passage and first tubular part with a first opening at one end leading into the passage and a second opening at its opposite end leading into the passage, the body being adapted to be secured to a container, e.g. with non-rigid walls;

a cap removably fitted over the body for closing the first opening to the passage;

a first sealing disc of plastics material, and being adapted to sealingly close off the second opening to the passage in the body, and being adapted to open the second opening mechanically when an inflation device is inserted into the second opening and thus gas is inserted into the container through the second opening into the passage and thereby moving away from the second opening;

a guide member located within the first tubular part; and

a spring associated with the first sealing disc and supported by the guide member, the spring being adapted to assist the first sealing disc to close off the second opening, the spring having an expanded height of between about 20 to 30 millimeters (mm) and a contracted height of between about 2 to 10 mm.

Also according to the invention is provided a method of inflating containers with non-rigid walls, includes the steps:

inserting air and/or gas into a container with non-rigid walls through a body including a passage and a first tubular part with a first opening at one end leading into the passage and a second opening at its opposite end leading into the passage, the body being adapted to be secured to the container;

mechanically opening the second opening by means of a first sealing disc of plastics material when an inflation device is inserted into the second opening and thus gas is inserted into the container through the second opening into the passage and thereby moving away from the second opening;

sealingly closing off the second opening by means of the first sealing disc of plastics material, the first sealing disc being operated by means of a spring and supported by a guide member located within the first tubular part, the spring being adapted to assist the first sealing disc to close off the second opening, the spring having an expanded height of between about 20 to 30 mm and a contracted height of between about 2 to 10 mm; and

Fitting a cap over the body for closing the first opening to the passage.

The invention also extends to a container with non-rigid walls provided with an inflation valve as set out herein.

The valve may include means for deflating the container. The deflating means may include a tubular part with a cap member. The deflating means may include at least one aperture in the tubular part and/or the cap member.

The deflating means may be adapted to open the second opening mechanically when the deflating means is inserted into the second opening and thus gas may exit out of the container through the second opening.

The deflating means may also include locking means for locking the deflating means to assist in the deflating of the container.

The cap may be connected to the body by means of a connecting strip made of plastics material.

The valve may include a handle for stabilising the valve whilst the container is being inflated. The handle may be connected to the body by means of a connecting strip made of plastics material.

The cap and/or the handle and/or the body and/or the deflating means may be integrally formed. The cap and the handle may be integrally formed and include a ring member adapted to be removably located around the body.

The spring may be conically-shaped and may be formed of metal or plastics material.

The guide member may be made of plastics material.

The spring and/or the body and/or the guide member may be integrally formed.

The valve may be used by venturi air flow guns and devices.

The air entering the container through the inflation valve may have an absolute pressure of about 9 bar.

The body may be provided with a flange for securing the inflation valve to the container.

The container may be a dunnage bag, a sack and/or any other flexible container to be pressurized.

The body and the cap may include cooperating threads and/or other formations.

The first tubular part may be provided with an external thread and the cap with an associated internal thread.

The inflation device may include a filling nozzle having cooperating threads with the body.

The valve may be provided with a second sealing disc located between the cap and the body and being adapted to close off the first opening.

The cap may include a tubular side wall. The tubular side wall may be provided with an internal thread for cooperating with the external thread of the first tubular part.

The tubular part of the deflation means (or second tubular part) may converge towards the second opening.

The body may be made of plastics and may be injection moulded.

The cap may be made of plastics and may be injection moulded.

The sealing discs may be made of polyethylene sheet material, resilient plastics or rubber or silicon.

The valve may be a one-way or semi-one way valve.

### BRIEF DESCRIPTION OF THE DRAWINGS

The foregoing and other objects and advantages of the invention and the manner in which the same are accomplished will become clearer based on the following detailed description taken in conjunction with the accompanying drawings in which:

FIG. 1 is a perspective view of an inflation valve in accordance with the invention;

FIG. 2 is a top view of the inflation valve as seen along arrow II in FIG. 1;

FIG. 3 is a side view of the inflation valve as seen along arrow III in FIG. 2;

FIG. 4 is a front view of the inflation valve as seen along arrow IV in FIG. 3;

FIG. 5 is a perspective view of an inflation valve in accordance with a second embodiment of the invention, including deflating means; and

FIG. 6 is a perspective view of an inflation valve in accordance with a third embodiment of the invention, including deflating means but excluding a cap.

### DETAILED DESCRIPTION

The present invention will now be described more fully hereinafter with reference to the accompanying drawings, in which a preferred embodiment of the invention is shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

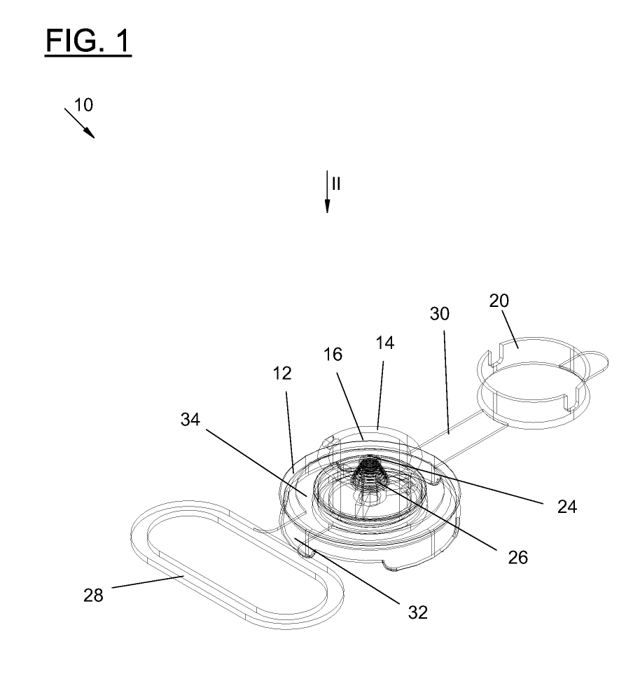

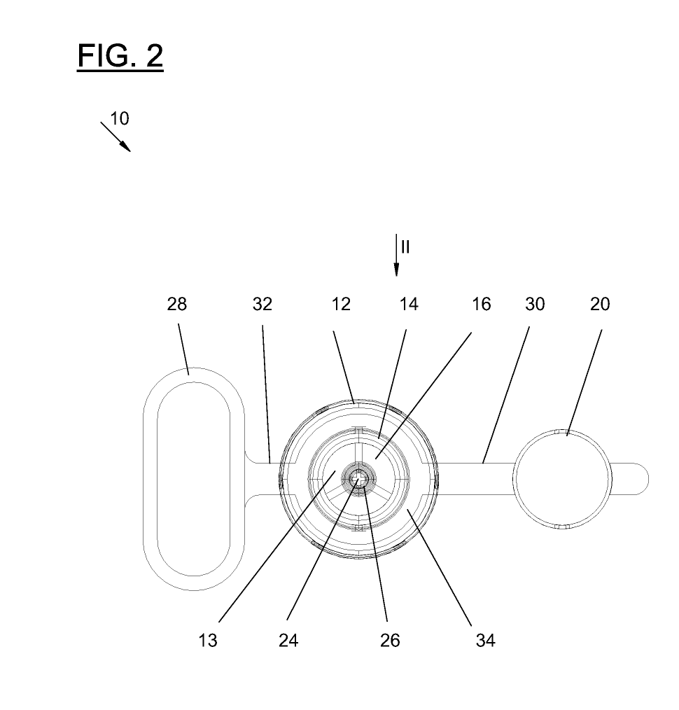

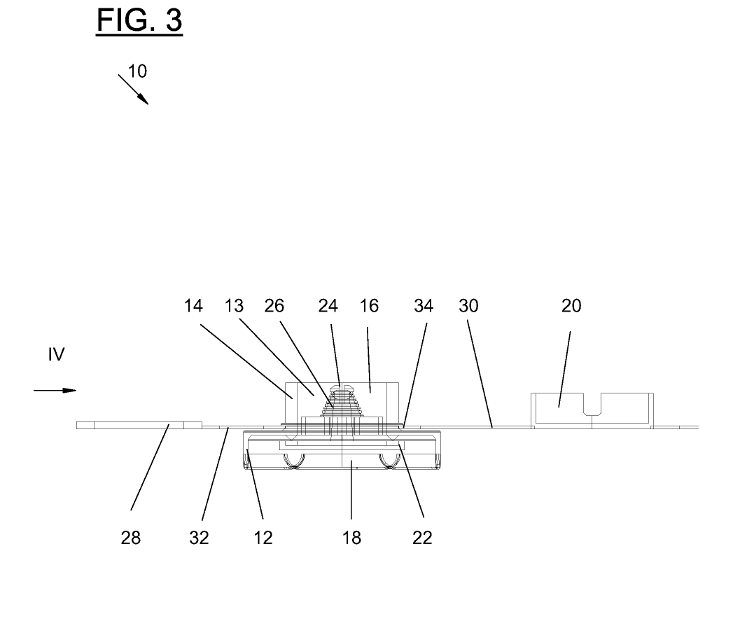

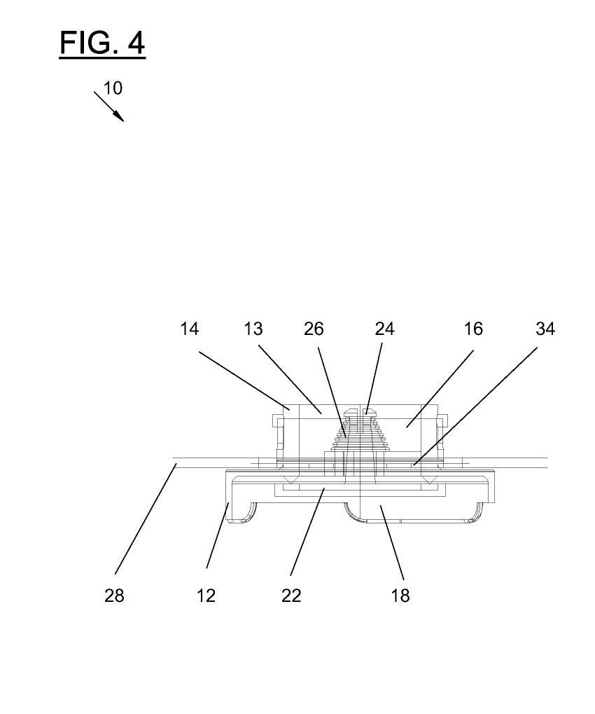

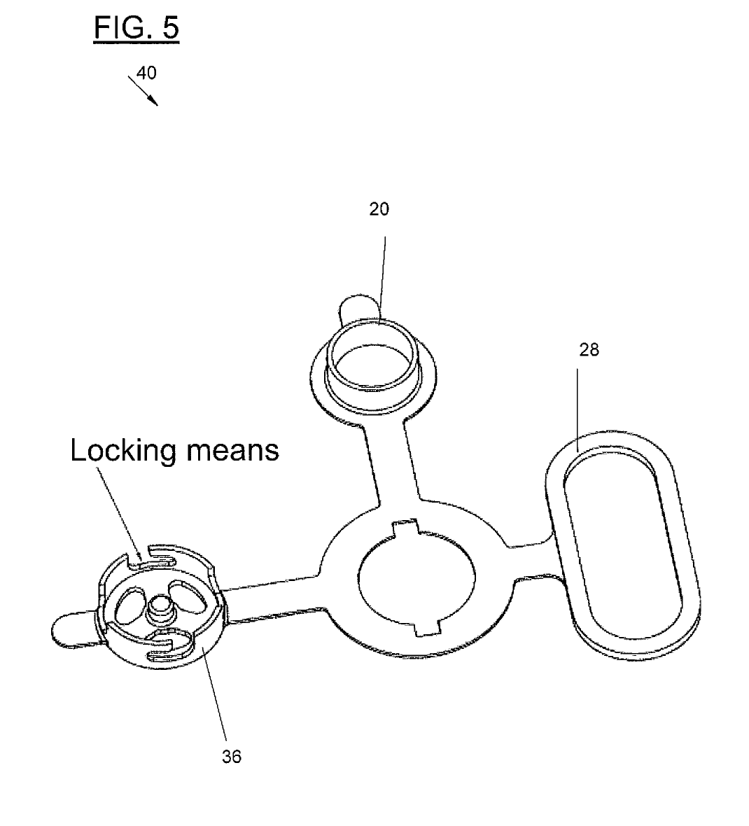

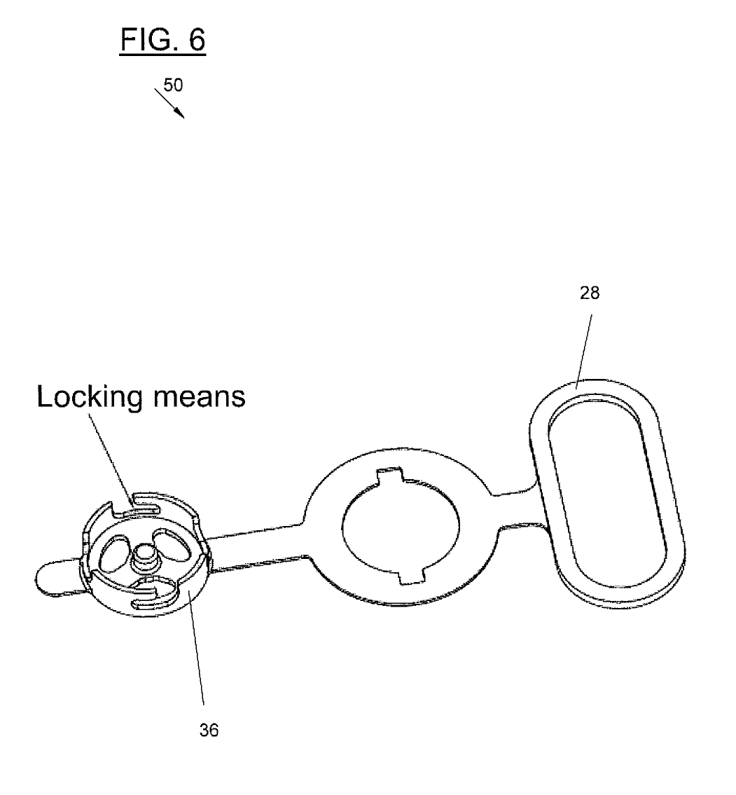

Referring to FIGS. 1 to 7, an inflation valve in accordance with the invention, generally indicated by reference numeral 10, is shown. In FIG. 6, the inflation valve in accordance with a second embodiment of the invention, is indicated by reference numeral 40. In FIG. 7, the inflation valve in accordance with a third embodiment of the invention, is indicated by reference numeral 50.

The inflation valve 10 (or 40 or 50) for inflating containers with non-rigid walls, includes:

a body 12 defining a passage 13 and first tubular part 14 with a first opening 16 at one end leading into the passage 13 and a second opening 18 at its opposite end leading into the passage 13, the body 12 being adapted to be secured (i.e., for securement) to a container with non-rigid walls;

a cap 20 removably fitted over the body 12 for closing the first opening 16 to the passage 13;

a first sealing disc 22 of plastics material, and being adapted to sealingly close off the second opening 18 to the passage 13 of the body 12, and being adapted to open the second opening 18 mechanically when an inflation device is inserted into the second opening 18 and thus gas is inserted into the container through the second opening 18 into the passage 13 and thereby causing the first sealing disc to move away from the second opening 18;

a guide member 24 located within the first tubular part 14; and

a spring 26 associated with the first sealing disc 22 and supported by the guide member 24, the spring 26 being adapted to assist the first sealing disc 22 to close off the second opening 18, the spring 26 having an expanded height of between about 20 to 30 mm and a contracted height of between about 2 to 10 mm.

The cap 20 is connected to the body by means of a first connecting strip 30 made of plastics material.

The valve 10 may include a handle 28 for stabilizing the valve 10 whilst the container is being inflated. The handle 28 may be connected to the body 12 by means of a second connecting strip 32 made of plastics material.

The cap 20 and the handle 28 may be integrally formed and include a ring member 34 adapted to be removably located around the body 12.

The spring 26 is conically-shaped and is made of metal, but can also be made of plastics material. The spring 26 and the body 12 can be integrally formed.

The valve 10 is generally used by venturi air flow guns and devices or other inflation devices. The inflation devices generally include a filling nozzle having cooperating threads with the body 12.

The valve may also include a second sealing disc for sealing or closing off the first opening 16. The second sealing disc is positioned between the cap and the body.

The cap may include a tubular side wall. The tubular side wall may be provided with an internal thread for cooperating with the external thread of the first tubular part.

Air entering the container through the inflation valve 10 generally has an absolute pressure of about 9 bar.

The body 12 can also be provided with a flange for securing the inflation valve 10 to the container. The container is a dunnage bag, a sack or any other flexible container to be pressurized.

The body 12 and the cap 20 include cooperating threads or other formations. The first tubular part 14 is provided with an external thread and the cap 20 with an associated internal thread.

The body 12 is made of plastics material and is injection moulded.

The cap 20 is made of plastics material and is injection moulded.

The sealing disc 22 is made of polyethylene sheet material, resilient plastics or rubber or silicon.

The valve 10 is thus a one-way or semi-one way valve.

The inflation valve 10 includes a means for deflating 36 the container. The deflating means 36 includes a tubular part with a cap member and at least one aperture in the tubular part and the cap member. The tubular part of the deflating means 36 converges towards the second opening 18 in the body. The deflating means 36 is adapted to open the second opening mechanically when the deflating means 36 is inserted into the second opening 18 and thus gas may exit out of the container through the second opening 18. The deflating means 36 may include locking means for locking the deflating means 36 to assist in the deflating of the container.

In another embodiment, the invention is directed to an inflatable container with non-rigid walls comprising an inflation valve 10, 40, 50 for inflating the container as discussed herein above. The inflation valve 10 may include a body 12, a cap 20, at least one sealing disc 22, a guide member 24, a spring 26, and means for deflating 36 the container.

The body 12 is secured to an opening defined by the container, wherein the body 12 defines a passage 13 and at least one tubular part (or first tubular part) 14 that defines a first opening 16 and a second opening 18 leading into the passage 13. The first and second openings 16, 18 are positioned at opposing ends of the tubular part 14.

The inflation valve 10 may also include a cap 20 removably fitted over the body 12 for closing the first opening 16 to the passage 13. At least one sealing disc 22 is provided for sealing the second opening 18 to the passage 13 in the body 12. The sealing disc 22 opens the second opening 18 mechanically when a gas is injected by an inflation device into the second opening 18 and passage 13, and causes the sealing disc 22 to move away from the second opening 18.

A guide member 24 is located within the first tubular part 14 and a spring 26 associated with the sealing disc 22 is supported by the guide member. The spring 26 assists the sealing disc 22 to seal the second opening 18.

The inflation valve 10 of the container may also include any number of other elements discussed herein above.

Thus in accordance with the invention, containers with non-rigid walls such as dunnage bags can be inflated by means of inflation devices by means of the following steps:

inserting air and/or gas into a container with non-rigid walls through a body 12 including a passage 13 and a first tubular part 14 with a first opening 16 at one end leading into the passage 13 and a second opening 18 at its opposite end leading into the passage 13, the body 12 being adapted to be secured to the container;

mechanically opening the second opening 18 by means of a first sealing disc 22 of plastics material when an inflation device is inserted into the second opening 18 and thus gas is inserted into the container through the second opening 18 into the passage 13 and thereby causing the first sealing disc to move away from the second opening 18;

sealingly closing off the second opening 18 by means of the first sealing disc 22 of plastics material, the first sealing disc 22 being operated by means of a spring 26 and supported by a guide member 24 located within the first tubular part 14, the spring 26 being adapted to assist the first sealing disc 22 to close off the second opening 18, the spring 26 having an expanded height of between about 20 to 30 mm and a contracted height of between about 2 to 10 mm; and

of fitting a cap 20 over the body for closing the first opening 16 to the passage 13.

The method may also include the step of deflating the container after the fitting step by means of deflating the container associated with a valve.

In use the inflation valve 10 is secured to a container, such as a dunnage bag, a sack or other containers with non-rigid walls.

When filling the container, a gas filling nozzle of an inflation device is connected by means of an adapter to the inflation valve 10. The gas inserted pushes the first sealing disc 22 away from the body 12 and thus the gas can enter the container through the opening 18. Thereby, the inflation valve 10 is opened and allows inflation of the container. When removing the gas filling nozzle, the first sealing disc 22 moves to its original position as a result of the action of the spring and sealingly fits over the opening 18. The pressure of gas inside the container facilitates the sealing of the opening 18 by means of the sealing disc 22.

Furthermore, in order to ensure that the gas filling nozzle is locked once inserted in the opening 16, the gas filling nozzle is provided with an internal thread which cooperates with an external thread of the body 12.

1. An inflation valve for inflating containers with non-rigid walls, the inflation valve comprising:
a body for securement to a container, the body defining a passage and a first tubular part defining a first opening at one end leading into the passage and a second opening at an opposite end of the first tubular part leading into the passage;
a cap removably fitted over the body for closing the first opening to the passage;
a first sealing disc for sealingly closing off the second opening to the passage in the body, the first sealing disc for opening the second opening mechanically when an inflation device is inserted into the second opening and gas is inserted into the container through the second opening into the passage and thereby causing the first sealing disc to move away from the second opening;
a guide member located within the first tubular part; and
a spring associated with the first sealing disc and supported by the guide member, the spring for assisting the first sealing disc to close off the second opening, the spring having an expanded height of between about 20 to 30 millimeters and a contracted height of between about 2 to 10 millimeters.

2. A valve as claimed in claim 1, wherein the cap is connected to the body by means of a connecting strip.

3. A valve as claimed in claim 1, further comprising means for deflating the container.

4. A valve as claimed in claim 3, wherein the deflating means comprises a tubular part with a cap member, the tubular part converging towards the second opening in the body.

5. A valve as claimed in claim 4, wherein the deflating means defines at least one aperture in the tubular part and/or the cap member.

6. A valve as claimed in claim 3, wherein the second opening is mechanically opened when the deflating means is inserted into the second opening and gas exits out of the container through the second opening.

7. A valve as claimed in claim 3, wherein the deflating means further comprises a locking means.

8. A valve as claimed in claim 1, further comprising a handle for stabilizing the valve whilst the container is being inflated, the handle connected to the body by means of a connecting strip.

9. A valve as claimed in claim 8, wherein the cap, the handle, and the body are integrally formed.

10. A valve as claimed in claim 8, wherein the cap and the handle are integrally formed and include a ring member adapted to be removably located around the body.

11. A valve as claimed in claim 1, wherein the spring, the body, and the guide member are integrally formed.

12. A valve as claimed in claim 1, wherein the valve is compatible with any number of inflation devices.

13. A valve as claimed in claim 1, wherein the air entering the container through the inflation valve has an absolute pressure of about 9 bar.

14. A valve as claimed in claim 1, wherein the body is provided with a flange for securing the inflation valve to the container.

15. A valve as claimed in claim 1, wherein the container is selected from the group consisting of a dunnage bag, a sack and any other flexible container to be pressurized.

16. A valve as claimed in claim 1, wherein the first tubular part is provided with an external thread and the cap with an associated internal thread.

17. A valve as claimed in claim 1, further comprising a filling nozzle having cooperating threads with the body.

18. A valve as claimed in claim 1, further comprising a second sealing disc located between the cap and the body, the second sealing disc for closing off the first opening.

19. A valve as claimed in claim 1, wherein the cap defines a tubular side wall.

20. A valve as claimed in claim 19, in which the tubular side wall is provided with an internal thread for cooperating with the external thread of the first tubular part.

21. A valve as claimed in claim 1, wherein the valve is a one-way or semi-one way valve.

22. An inflatable container with non-rigid walls comprising:
an inflation valve for inflating the container, the inflation valve having:
a body secured to an opening defined by the container, the body defining a passage and at least one tubular part that defines a first opening and a second opening leading into the passage, the first and second openings positioned at opposing ends of the at least one tubular part;
a cap removably fitted over the body for closing the first opening to the passage;
at least one sealing disc for sealing the second opening to the passage in the body, the at least one sealing disc for opening the second opening mechanically when a gas is injected by an inflation device into the second opening and passage, and causes the at least one sealing disc to move away from the second opening;
a guide member located within the at least one tubular part; and
a spring associated with the at least one sealing disc and supported by the guide member, the spring for assisting the at least one sealing disc to seal the second opening.

23. A method of inflating containers with non-rigid walls, the method comprising the steps of:
inserting gas into a container with non-rigid walls through a body defining a passage and a first tubular part having a first opening at one end leading into the passage and a second opening at an opposite end of the first tubular part leading into the passage, the body for securement to the container;
mechanically opening the second opening by means of a first sealing disc when an inflation device is inserted into the second opening and gas is inserted into the container through the second opening into the passage and thereby causing the first sealing disc to move away from the second opening;
sealingly closing off the second opening by means of the first sealing disc, the first sealing disc being operated by means of a spring and supported by a guide member located within the first tubular part, the spring being adapted to assist the first sealing disc to close off the second opening, the spring having an expanded height of between about 20 to 30 millimeters and a contracted height of between about 2 to 10 millimeters; and
fitting a cap over the body for closing the first opening to the passage.

24. A method as claimed in claim 23, further comprising the step of deflating the container by a means of deflating the container associated with a valve.
